(19) United States
(12) Patent Application Publication
(10) Pub. No.: US 2010/0302482 A1
(43) Pub. Date: Dec. 2, 2010

(54) COLOR FILTER SUBSTRATE, LIQUID CRYSTAL DISPLAY PANEL, LIQUID CRYSTAL DISPLAY DEVICE, AND PRODUCTION METHOD OF COLOR FILTER SUBSTRATE

(76) Inventors: Keiji Takahashi, Osaka (JP); Shingo Johgan, Osaka (JP); Hisashi Nagata, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/744,983

(22) PCT Filed: Sep. 9, 2008
(86) PCT No.: PCT/JP2008/066256

§ 371 Date: May 27, 2010

(30) Foreign Application Priority Data
Nov. 29, 2007 (JP) 2007-308657

(51) Int. Cl. G02F 1/1335

(52) U.S. Cl. 349/106; 349/187

(57) ABSTRACT

The present invention provides a color filter substrate which achieves a sufficient light-shielding effect in a light-shielding region and can prevent a disorder of the alignment of liquid crystals in the vicinity of the light-shielding region. The present invention is a color filter substrate including: a light-shielding layer and a colored layer made of material such as a photosensitive material, on a substrate, wherein the colored layer is arranged from a light transmission region not having the light-shielding layer arranged therein to a light-shielding region having the light-shielding layer arranged therein, and has a smaller thickness in the light-shielding region than in the light transmission region.

### TECHNICAL FIELD

The present invention relates to a color filter substrate, a liquid crystal display panel, a liquid crystal display device, and a production method of a color filter substrate. More particularly, the present invention relates to a color filter substrate suitable for a vertical alignment liquid crystal display device, a liquid crystal display panel and a liquid crystal display device each having the color filter substrate, and a production method of a color filter substrate.

### BACKGROUND ART

Liquid crystal display devices are display devices with slim profile and low power consumption and are being widely used in OA (office automation) equipment such as a PC, PDAs such as an electronic notebook and a cellular phone, monitors for camcorders, and the like. Liquid crystal display devices are desired to have a variety of characteristics, particularly higher display qualities. This has led to further development of a color filter substrate to be provided in a liquid crystal display panel for color display.

A color filter substrate has a black matrix (light-shielding layer) and colored layers of red, green, blue etc. A colored layer is mainly formed in a light transmission region in which a black matrix is not arranged. At this time, if the arranged colored layer is smaller than the light transmission region, the light transmission region allows light to be transmitted through the parts where the colored layer is not arranged, whereby the transmitted light, uncolored, decreases display qualities such as a contrast ratio. Accordingly, a colored layer is generally formed such that the colored layer overlies the black matrix surrounding the light transmission region.

When the colored layer overlies the black matrix, the thickness of the black matrix and the thickness of the colored layer overlying the black matrix produce a part more bulging than the light transmission layer. Since the colored layer is continuously arranged from the light transmission region to a light-shielding region, the bulge on the black matrix causes a bulge of the colored layer in the light transmission region near the light-shielding region. For this reason, application of such a color filter substrate in a liquid crystal display device causes a change in the alignment of liquid crystal molecules due to the bulge of the colored layer, which may possibly lead to a decrease in the display qualities, such as light leakage, a decrease in the contrast ratio, and a decrease in the color reproduction quality.

Patent Document 1 discloses a method of forming a three-colored black matrix layer in order to produce a color filter substrate with a surface of good flatness. The three-colored black matrix layer is formed at the same time with formation of colored layers of the filter, by laminating thin colored layers of three colors, each with a smaller thickness than the colored layers of the filter, through a photomask that has a half-tone mask portion in the light-shielding portion of the color filter.

### [Patent Document 1]

Japanese Kokai Publication No. Hei-08-95021

### DISCLOSURE OF INVENTION

Such a black matrix formed by laminating three colored layers according to Patent Document 1 can have a very large thickness unless the colored layers have a sufficiently small thickness. This may possibly produce a stepped part between the light-shielding region and the light transmission region, leading to an alignment disorder of liquid crystals. Meanwhile, the colored layers of the respective colors having a very small thickness also have room for improvement in that such colored layers do not achieve a sufficient light-shielding effect and thus lead to a decrease in a contrast ratio.

The present invention has been made in view of the above-mentioned state of the art. The present invention aims to provide a color filter substrate, a liquid crystal display panel, a liquid crystal display, and a production method of a color filter substrate that are capable of achieving a sufficient light-shielding effect in a light-shielding region while suppressing an alignment disorder of liquid crystals near the light-shielding region.

The present inventors have made various investigations on color filter substrates. The inventors have noted that arranging a colored layer from a light transmission region not having a light-shielding layer arranged therein to a light-shielding region having a light-shielding layer arranged therein makes it possible to prevent light leakage and to improve a contrast ratio but produces a bulge from the light transmission region to the light-shielding region. The inventors have also found that reducing the thickness of the colored layer in the light-shielding region to smaller than the thickness of the colored layer in the light transmission region allows reduction of the bulge generating from the light transmission region to the light-shielding region. The reduction of the bulge leads to prevention of an alignment disorder of liquid crystal molecules and prevention of a decrease in the display qualities. This has admirably solved the above-mentioned problems, leading to completion of the present invention.

That is, the present invention is a color filter substrate including: a light-shielding layer and a colored layer on a substrate, wherein the colored layer is arranged from a light transmission region not having the light-shielding layer arranged therein to a light-shielding region having the light-shielding layer arranged therein, and has a smaller thickness in the light-shielding region than in the light transmission region.

The present invention is described in detail below.

The color filter substrate of the present invention includes a light-shielding layer and a colored layer on a substrate. The above substrate is preferably a transparent substrate such as a glass substrate or a plastic substrate, from a perspective that the substrate is to be provided in a display device.

The above light-shielding layer is made of a black material, and examples thereof include photosensitive resins containing a black pigment, and black metallic materials such as chromium. In terms of achieving a sufficient light-shielding effect, the light-shielding layer preferably has an optical density of three or higher. Also, the configuration of the above light-shielding layer is not limited to the general arrangements such as a grid pattern surrounding each light transmission region, and a stripe pattern.

The above colored layer means a layer capable of selectively transmitting a larger amount of a visible light with a specific wavelength range than other visible lights. Examples thereof include layers of white, which is an achromatic color, as well as of the three colors of red, green, and blue. The material of the colored layers is not particularly limited, and examples thereof include resins colored by a dye, resins in which a pigment is dispersed, and materials produced by solidifying a fluid material (ink). Particularly in formation of a colored layer by photolithography, a photosensitive resin colored by a dye and a photosensitive resin in which a pigment is dispersed are preferably used. The method of forming a colored layer is not particularly limited, and examples thereof include a spin coat method, a dyeing method, a pigment dispersion method, an electrodeposition method, a print method, an ink jet method, and a color resist method (also referred to as a “transfer method”, a “dry film laminating (DFL) method”, or a “dry film resist method”).

In the present invention, the colored layers each are arranged from a light transmission region not having the light-shielding layer arranged therein to a light-shielding region having the light-shielding layer arranged therein, and has a smaller thickness in the light-shielding region than in the light transmission region. This configuration allows suppression of a bulge of the colored layer from the light transmission region to the light-shielding region. Hence, in application of the color filter substrate of the present invention to a liquid crystal display device, the configuration makes it possible to suppress an alignment disorder of liquid crystal molecules, improving the display qualities. Note that the light transmission region means a region where the light-shielding layer is not arranged, and the light-shielding region means a region where the light-shielding layer is arranged.

The improvement in the display qualities according to the present invention can be explained as follows. Generally, a colored layer is preferably arranged over the entire light transmission region used for display, in terms of prevention of the light leakage in a liquid crystal display device. However, densely arranging a colored layer between a light-shielding region and a light transmission region without allowing the colored layer to overlap with the light-shielding layer is difficult in the production process. In contrast, consider a case that each colored layer is formed from a light transmission region to a light-shielding region continuously, that is, a colored layer is formed in a light transmission region and on/under a light-shielding layer in a light-shielding region so as to be continuous from the light transmission region to the light-shielding region. This case allows prevention of light leakage near the light-shielding region. In this configuration, however, the light-shielding layer and the colored layer overlap with each other in the light-shielding region, and thus the colored layer greatly bulges from the light transmission region to the light-shielding region. In such a case, application of the color filter substrate in a liquid crystal display device may possibly lead to an alignment disorder of liquid crystal molecules due to the stepped part of the color filter substrate, decreasing the display qualities. In the present invention, the colored layers in the light-shielding regions have a thickness smaller than the thickness of the colored layers in the light transmission regions so as to prevent the colored layers from greatly bulging from the light transmission regions to the light-shielding regions. As a result, application of the color filter substrate to a liquid crystal display panel makes it possible to suppress an alignment disorder of the liquid crystal molecules.

Each colored layer in the light transmission region only needs to have a larger thickness than the colored layer in the light-shielding region at the thickest part thereof, and may have parts having a thickness equal to or smaller than the thickness of the colored layer in the light-shielding region. In the case that the total thickness of the light-shielding layer and the colored layer in the light-shielding region is larger than the thickness of the colored layer in the light transmission region, the difference between these thicknesses is preferably 0.5 μm or less. In the case that the height of the colored layer in the light transmission region is zero, the colored layer on the light-shielding layer or the light-shielding layer on the colored layer preferably has a height of 0.5 μm or less. A thickness exceeding 0.5 μm produces a great bulge from the light transmission region to the light-shielding region, possibly causing an alignment disorder in the liquid crystal display panel. Since a thickness of 0.5 μm or less can reduce a bulge of the colored layer from the light transmission region to the light-shielding region, generation of the alignment disorder of the liquid crystal molecules in the liquid crystal display panel can be more sufficiently suppressed.

The above colored layer may be arranged on the light-shielding layer (on the opposite side of the substrate of the light-shielding layer), or may be arranged under the light-shielding layer (between the light-shielding layer and the substrate). Arranging the colored layer under the light-shielding layer allows the colored layer to have a more uniform thickness than in the case of arranging the colored layer on the light-shielding layer, thereby further facilitating control of the thickness of the colored layer in the light-shielding region.

The color filter substrate of the present invention is not specifically limited as long as it includes the above substrate, the light-shielding layer, and the colored layer, and may or may not include other components. For example, the color filter substrate of the present invention preferably includes a common electrode for driving the pixels that form a display image. In the case of being provided in a liquid crystal display panel, the color filter substrate of the present invention preferably includes an alignment layer for controlling the alignment of liquid crystal molecules. In the case of being provided in a vertical alignment liquid crystal display panel, the color filter substrate of the present invention preferably includes a vertical alignment layer. The color filter substrate of the present invention is applicable not only in a liquid crystal display device but also in other display devices to be provided with a color filter substrate. For example, the color filter substrate of the present invention is applicable in an organic electroluminescence (EL) display device which provides display through a color filter.

Other preferable embodiments of the color filter substrate according to the present invention are described in detail below.

An example of preferable embodiments of the colored layer is an embodiment that includes a first colored layer and a second colored layer that are adjacent to each other, sandwiching the light-shielding layer, and do not overlap with each other in the light-shielding region. Since the first colored layer and the second colored layer do not overlap with each other, the total thickness of the light-shielding layer and the colored layer can be made smaller than in the case that the colored layers arranged in the light-shielding layer overlap with each other. Accordingly, the total height of the light-shielding layer and the colored layer arranged in the light-shielding region, and the height of the surface of the colored layer in the region not having the light-shielding layer therein can be further uniformed. Thereby, in a liquid crystal display device provided with the color filter substrate of the present invention, the alignment disorder of the liquid crystal molecules can be further suppressed. The first colored layer and the second colored layer are separately formed, and are preferably of colors different from each other because liquid crystal display devices with a color filter substrate usually provide display in multiple colors. The colors of the colored layers may be, for example, three colors of red, green, and blue, three colors of cyan, magenta, and yellow, or four or more colors.

Examples of the embodiment having the first colored layer and the second colored layer not overlapping with each other include embodiments in which the first colored layer and the second colored layer are not in contact with each other. Such an embodiment has a benefit in that the first colored layer and the second colored layer do not easily overlap with each other even if the colored layers are mispatterned in the production process. The first colored layer and the second colored layer are preferably not arranged across the center of the light-shielding layer (the position at which the distances from the two light transmission regions sandwiching the light-shielding layer are equal). Arranging the first colored layer and the second colored layer equally on the light-shielding layer without allowing them to cross the center of the light-shielding layer makes it possible to minimize the possibility for the light transmission region to have a part without the colored layer arranged therein in the case that the first colored layer or the second colored layer is mispatterned.

Examples of the preferable embodiments of the colored layer further include an embodiment in which the colored layer has a smaller thickness at a part ranging from the light-shielding region to an end of the light transmission region, than at a center part of the light transmission region. In this embodiment, since the colored layer has a smaller thickness at an end of the light transmission region around the light-shielding region, than at a center part of the light transmission region, a stepped part is produced in which the height of the colored layer decreases from the center of the light transmission region toward the end of the light transmission region. In the case that the colored layer overlies the light-shielding layer in the process of producing a color filter substrate, a bulge may be formed not only in the light-shielding region but also at the end of the light transmission region. For this reason, formation of a bulge at a part ranging from the light transmission region to the light-shielding region may not be sufficiently suppressed by reducing only the thickness of the colored layer in the light-shielding region. Accordingly, the thickness of the colored layer at the end of the light transmission region should also be reduced in order to suppress the formation of a bulge of the colored layer. Further, for example, in the case that the color filter substrate of the present invention is to be provided in a liquid crystal display device which provides display in a vertical alignment mode with a projection for liquid crystal alignment control, the tilt direction of the side of the projection is made the same as the tilt direction of the stepped part of the colored layer at the end of the light transmission region. This allows the alignment direction of the liquid crystal molecules alignment-controlled by the projection to be continuous with the alignment direction of the liquid crystal molecules alignment-controlled by the stepped part of the colored layer. As a result, more stabilized liquid crystal alignment can be achieved. Thus, in the case of being provided in a liquid crystal display device providing display in a vertical alignment mode, the color filter substrate of the present invention preferably has on the colored layer a projection for liquid crystal alignment control the tilt direction of which is the same as the tilt direction of the stepped part of the colored layer at the end of the light transmission region. Further, in the case that the projection has a cross-sectional shape with a high center part, the angular difference is more preferably small between the tilt angle of the side of the projection and the tilt angle of the stepped part in which the height of the colored layer at the end of the light transmission region is low.

The total thickness of the light-shielding layer and the colored layer in the light-shielding region is preferably not larger than the thickness of the colored layer in the light transmission region. That is, the thickness of the colored layer arranged in the light transmission region is preferably equal to or larger than the total thickness of the light-shielding layer and the colored layer arranged in the light-shielding region. This means that the height of the surface of the colored layer arranged in the light-shielding region is equal to or lower than the height of the surface of the colored layer arranged in the light transmission region, whereby an alignment disorder of liquid crystal molecules can be suppressed. For example, consider the case that the color filter substrate of the present invention is to be provided in a vertical alignment liquid crystal display device. In this case, the colored layer, if having a bulge from the light transmission region to the light-shielding region, may possibly cause the alignment direction of the liquid crystal molecules alignment-controlled by the projection to be noncontinuous with the alignment direction of the liquid crystal molecules alignment-controlled by the bulge of the colored layer, leading to an alignment disorder of the liquid crystal molecules. In the case that the colored layer arranged in the light transmission region has different thicknesses according to places, the largest thickness of the colored layer in the light transmission region may be equal to or larger than the largest total thickness of the shielding layer and the colored layer arranged in the light-shielding region.

The colored layer in the above light-shielding region is preferably arranged on the above light-shielding layer. In this case, the shape of the light-shielding layer is not affected by the shape of the colored layer, unlike the case in which the light-shielding layer is arranged on the colored layer. The light-shielding layer therefore can have a more uniform shape with a more uniform thickness. In the case that the colored layer is arranged under the light-shielding layer, for example, two kinds of colored layers sandwich the light-shielding layer without overlapping with each other under the light-shielding layer. In such a case, the layers are formed with a space therebetween. The light-shielding layer may be formed on a stepped part produced by the two kinds of colored layers and the space therebetween, which may possibly cause the light-shielding layer to have different thicknesses in a part overlapping with the colored layer and in a part not overlapping with the colored layer.

The present invention is also a liquid crystal display panel provided with the above color filter substrate. Examples of the components constituting the liquid crystal display panel of the present invention, other than the above color filter substrate, include counter substrates, such as a thin film transistor (TFT) array substrate, and liquid crystal layers sandwiched by the above color filter substrate and a counter substrate. Further, the present invention is also a liquid crystal display device provided with the above liquid crystal display panel. Examples of components constituting the liquid crystal display device of the present invention, other than the above liquid crystal display panel, include polarizers, retardation films, and drivers for display pixel driving. The liquid crystal display panel and the liquid crystal display device of the present invention can stabilize the liquid crystal alignment by virtue of being provided with the above color filter substrate.

The liquid crystal display panel of the present invention preferably provides display in a vertical alignment mode. For example, consider the case that the liquid crystal display panel provides display in a vertical alignment mode with a projection for alignment control. In this case, if there is a bulge of the colored layer from the light transmission region to the light-shielding region, the liquid crystal molecules aligned at an angle by the projection collide against the liquid crystal molecules aligned according to the bulge of the colored layer, whereby the alignment may possibly be destabilized. Reducing the thickness of the colored layer in the light-shielding region as in the present invention makes it possible to suppress generation of a bulge in the light-shielding region, which makes the alignment directions of the liquid crystal molecules uniform and thus suppresses an alignment destabilization. That is, in the case that the liquid crystal display panel of the present invention provides display in a vertical alignment mode, the color filter substrate preferably includes a projection for alignment control.

The projection for liquid crystal alignment control is not particularly limited so long as the projection can control the alignment of the liquid crystal molecules in the liquid crystal layer. The projection preferably contributes to formation of a domain, which is a region where the liquid crystal molecules are strongly relative to each other in their alignment, and is more preferably able to form multiple domains with equal areas in a pixel forming a display image. Provision of such a projection enables production of a multi domain liquid crystal display device such as an MVA (Multi-domain Vertical Alignment) liquid crystal display device, thereby achieving effects such as improvement in a wide viewing angle and a response rate. Examples of arrangement of the projections include dotted patterns and linear patterns. The projections are preferably arranged at substantially equal intervals in order to equalize responsivity of the liquid crystal molecules in the liquid crystal layer and thereby improve display qualities. The projections preferably have a tilt side surface, and for example have a conical shape when arranged in a dotted pattern. Further, the side surface is preferably tilted at a uniform angle from the top to the bottom. Note that the projections may not be provided in some vertical alignment liquid crystal display devices.

The present invention is also a production method of the color filter substrate, including the step of forming the colored layer by exposing through a half-tone mask or a gray tone mask a photosensitive material arranged on the substrate. The method enables to change the thickness of the colored layer in the light-shielding region and the light transmission region without increasing the number of production steps, and stabilizes the alignment of the liquid crystal molecules. Alternatively, for example, the colored layer on the light-shielding layer can be polished or treated in another way such that the light-shielding region and the light transmission region have the same height. However, in this case, a polishing process is to be added to the production process, possibly causing a decrease in productivity and an increase in a production cost. Further, in the case of making the heights same by polishing, it is difficult to uniform the height of the colored layer in the light transmission region and the height of the region in which the light-shielding layer and the colored layer overlap with each other. Exposure through a half-tone mask or a gray tone mask produces an exposure region exposed by the light for exposure and a non-exposure region shielded from the light for exposure, and can further produce a region exposed by an intermediate amount of the light for exposure for the above two regions by shielding a part of the light. This also makes it possible to uniform the heights of the light transmission region and the light-shielding region, and to intentionally control the thickness of the colored layer in the light transmission region and the light-shielding region so as to form the colored layer into a shape suitable for alignment of the liquid crystal molecules. Changing the amount of the transmitting light according to the region allows setting of several different amounts of the light for exposure, simplifying the production process.

The half-tone mask is an exposure mask made of a thinner light-shielding material than that for apart completely blocking the light for exposure so as to provide a part producing a reduced light-shielding effect, or is an exposure mask made of a film half-transmitting the light for exposure. Adjusting the light-shielding material thickness of the part that produces a reduced light-shielding effect, or changing the thickness, the kind etc. of the half-transmitting film allows adjustment of the exposure amount for the material, such as a photosensitive resin, of the colored layer. The half-transmitting film may be made of a material such as a molybdenum silicide film or quartz. A gray tone mask is an exposure mask having a part with narrow slits (openings) which blocks only a part of the light for exposure. The exposure amount therethrough can be controlled by adjusting the number of slits, the area, or the like.

The production method of the color filter substrate of the present invention is not particularly limited by other steps so long as the method includes the step of forming the colored layer by exposing through a half-tone mask or a gray tone mask a photosensitive material.

### EFFECT OF THE INVENTION

According to the color filter substrate of the present invention, the heights of the surface of the color filter substrate can be uniformed in the light-shielding region and the light transmission region. Hence, for example, in the case of being provided in a liquid crystal display panel, a liquid crystal display device, or the like, the color filter substrate of the present invention can stabilize the alignment of the liquid crystal molecules, and provide a sufficient contrast ratio.

### BEST MODES FOR CARRYING OUT THE INVENTION

The present invention is further described in detail based on the following Embodiments with reference to the drawings. The present invention is not limited to those Embodiments.

### Embodiment 1

FIG. 1 is a cross-sectional view schematically illustrating a configuration of a color filter substrate according to Embodiment 1.

As illustrated in FIG. 1, a color filter substrate 100 of Embodiment 1 has a light-shielding layer 13 with a thickness of 1 μm, made of a photosensitive resin containing a black pigment, on a transparent substrate 11 made of glass. The light-shielding layer 13 is formed in a grid pattern on the substrate surface of the transparent substrate 11, and is also called a black matrix (BM). The light-shielding layer 13 forms a light-shielding region 121 of a grid pattern which defines multiple light transmission regions 122 arranged corresponding to respective pixels.

From the light transmission regions 122 not having the light-shielding layer 13 arranged therein to the light-shielding region 121 having the light-shielding layer 13 arranged therein, colored layers of red, green, and blue are arranged. Although the colored layers are on the light-shielding layer 13 in the light-shielding region 121, adjacent colored layers (for example, a red colored layer 12R and a green colored layer 12G) sandwiching the light-shielding layer 13 do not overlap with each other. Note that FIG. 1 illustrates the boundary portion of the red colored layer 12R and the green colored layer 12G, and thus does not illustrate a blue colored layer. The red colored layer 12R and the green colored layer 120 each have a thickness d2 of 2 μm at a center portion 123 of the light transmission region 2-3 μm or more away from the light-shielding region 121, and has a thickness d1 of 1 μm on the light-shielding layer 13 and at an end 124 of the light transmission region within 2-3 μm from the light-shielding region 121.

In the present Embodiment, the colored layer has a smaller thickness (d1=1 μm or less) in the light-shielding region 121 than a thickness (d2=2 μm) in the light transmission region 122. The total thickness of the light-shielding layer 13 and the colored layer in the light-shielding region 121 is 2 μm or less, which is equal to or less than the thickness of the colored layer in the light transmission region 122. Accordingly, a bulge of the colored layer from the light transmission region 122 to the light-shielding region 121 is suppressed, whereby an alignment disorder of the liquid crystal molecules is suppressed. As a result, decreases in display qualities, such as a decrease in the contrast ratio, a decrease in the color reproduction effect, and generation of color irregularity, can be suppressed.

In the present Embodiment, the light-shielding layer 13 has a thickness of fpm, the colored layer in the light transmission region 122 has a thickness of 2 μm, and the colored layer on the light-shielding layer 13 has a thickness of 1 μm or less. Those thicknesses can be appropriately changed. The colored layer in the light transmission region preferably has a thickness of 1-3 μm. In the case that the total thickness of the light-shielding layer and the colored layer on the light-shielding layer is larger than the thickness of the colored layer in the light transmission region, the difference between these thicknesses is preferably 0.5 μm or less.

The colored layer has a common electrode (not illustrated) and a vertical alignment layer (not illustrated) arranged thereon over the entire substrate, in the stated order. Between the common electrode and the vertical alignment layer, a projection 16 for liquid crystal alignment control is arranged. The projection 16 is arranged as a dot (has a rivet shape) at the center of the light transmission region 122 surrounded by the light-shielding layer 13, and the cross-sectional shape of the projection 16 is conical.

FIG. 2 is a schematic view illustrating a cross-section of the vicinity of a color filter substrate in a liquid crystal display panel. FIG. 2 shows a relationship between the color filter substrate according to Embodiment 1 and the alignment of the liquid crystal molecules applied with no voltage. The liquid crystal panel is formed by attaching the color filter substrate 100 and a counter substrate which faces the substrate 100, and injecting therebetween liquid crystal materials that contain liquid crystal molecules with a negative dielectric constant. The counter substrate, the common electrode, the alignment layer, and the like are not illustrated in FIG. 2.

As illustrated in FIG. 2, liquid crystal molecules 18 on the side of the projection 16 are aligned at an angle to the substrate. At a stepped part where the height of the surface of the colored layer decreases from the light transmission region 122 to the light-shielding region 121 due to the decreased thickness of a part of the colored layer, the liquid crystal molecules 18 are also aligned at an angle to the substrate as with the molecules 18 around the projection 16. This allows the alignment direction of the liquid crystals to be uniform, enabling to provide more stable display.

The following (1) to (5) explain an example of the production method of the color filter substrate according to Embodiment 1 of the present invention.

### (1) Process of Forming Light-Shielding Layer

First, a light-shielding layer material such as a photosensitive resin containing a black pigment is applied on the transparent substrate 11, and then patterning is performed thereon by photolithography or the like to form the light-shielding layer 13.

### (2) Process of Forming Colored Layer

Next, a colored layer is formed. FIG. 3 is a cross-sectional view schematically illustrating an exposure process in patterning of a colored layer. FIG. 4 is a schematic cross sectional view illustrating the colored layer patterned through the exposure process. Note that the arrow in FIG. 3 indicates ultraviolet light (UV light) for exposure.

In the formation process of a colored layer, a transparent photosensitive resin 17R containing a red pigment for formation of the red colored layer 12R is first applied over the entire substrate by spin coating or the like. Then, as illustrated in FIG. 3, the transparent photosensitive resin 172 is exposed through a half-tone mask 110. Since a light transmission member 111 is used as the half-tone mask in an exposure region 120, the resin 17R is exposed by non-attenuated light for exposure. In the light-shielding region, a light-shielding member 114 of the half-tone mask 110 shields the resin from the light for exposure. In a half exposure region 130, the resin 17R is exposed through a light-shielding member 113, which is thinner than the light-shielding member in the light-shielding region 120, and a light transmission member 112. This reduces the exposure amount for the resin 172. After the exposure process, parts of the photosensitive resin not cured by the exposure are removed so that the red colored layer 122 of the shape illustrated in FIG. 4 is formed. The colored layer formed in the exposure region 120 serves as the center part of the region, and the colored layer formed in the half exposure region 130 serves as the end of the region. A green colored layer and a blue colored layer are also formed in the same way as the red colored layer 12R.

The colored layer may be patterned through a gray tone mask in place of the half-tone mask 100.

### (3) Process of Forming Common Electrode

A common electrode is formed over the entire substrate after formation of the colored layers. Here, a transparent conductive film of indium oxidation tin (ITO) etc. is formed by a method such as spattering, and the formed film is made to serve as the common electrode.

### (4) Process of Forming Projection for Liquid Crystal Alignment Control

On the common electrode, a photosensitive resin film is formed by spin coating etc. and is then patterned by photolithography or the like, whereby the projections 16 for liquid crystal alignment control can be formed.

### (5) Process of Forming Vertical Alignment Layer

A polyimide film etc. is formed over the entire substrate having the projections 16 for liquid crystal alignment control formed thereon, so that the vertical alignment layer is formed. Thereby, the color filter substrate 100 is completed.

Detailed descriptions are omitted for the process of producing a counter substrate and the process of attaching the color filter substrate 100 and the counter substrate together to produce a liquid crystal display panel because general methods can be adopted. To complete a liquid crystal display device, a polarizer, a retardation film, a driver etc. are mounted on the produced liquid crystal display panel.

### Embodiment 2

FIG. 5 is a cross-sectional view schematically illustrating a color filter substrate according to Embodiment 2.

As illustrated in FIG. 5, a color filter substrate 200 of Embodiment 2 has the same configuration as the color filter substrate 100 in Embodiment 1 except that the total thickness of a light-shielding layer 23 and a red colored layer 222 or a green colored layer 22G arranged on the light-shielding layer 23 is equal to the thickness of the red colored layer 22R or the green colored layer 22G arranged in a light transmission region 222.

The color filter substrate 200 has the light-shielding layer 23 with a thickness of 1 μm on a transparent substrate 21, and has the red colored layer 22R or the green colored layer 22G from the light transmission region 222 not having the light-shielding layer 23 arranged therein to a light-shielding region 221. At this time, the red colored layer 22R and the green colored layer 220 arranged in the light transmission region 222 each have a thickness d₄ of 2 μm, and the red colored layer 22R and the green colored layer 22G arranged on the light-shielding layer 23 each have a thickness d₃ of 1 μm. Allowing the total thickness of the light-shielding layer 23 and the colored layer in the light-shielding region 222 to be substantially the same as the thickness of the colored layer in the light transmission region 222 leads to uniform heights of the surfaces of the colored layers in the light transmission region 222 and the light-shielding region 221, improving the flatness of the color filter substrate. The color filter substrate, when constituting a liquid crystal display device, therefore can stabilize the alignment of the liquid crystal molecules. Further, the red colored layer 22R and the green colored layer 22G have thereon a common electrode which drives the pixels for displaying an image. On the common electrode, projections 26 for liquid crystal alignment control are arranged, and thereon a vertical alignment layer is arranged. In the present Embodiment, the light-shielding layer 23 has a thickness of 1 μm, the colored layer in the light transmission region 222 has a thickness of 2 μm, and the colored layer on the light-shielding layer 23 has a thickness of 1 μm or less. Those thicknesses can be appropriately changed. The colored layer in the light transmission region 222 preferably has a thickness of 1-3 μm.

### Comparative Example 1

FIG. 6 is a cross-sectional view schematically illustrating a configuration of a color filter substrate according to Comparative Example 1.

As illustrated in FIG. 6, a color filter substrate 300 of Comparative Example 1 has on a transparent substrate 31 a light-shielding layer 33 made of a photosensitive resin containing a black pigment. Colored layers of red, green, and blue each are arranged from a light transmission region 322 not having the light-shielding layer 33 arranged therein to a light-shielding region 321 having the light-shielding layer 33 arranged therein. Note that FIG. 5 illustrates the boundary portion of a red colored layer 32R and a green colored layer 32G, and thus does not illustrate a blue colored layer. The green colored layer 32G is formed to overlap with the red colored layer 32R, which increases the bulge of the red colored layer 32R formed on the light-shielding layer 33. For this reason, the color filter substrate 300 has a great irregularity on the surface thereof, and may possibly destabilize the alignment of liquid crystal molecules and decrease display qualities when provided in a liquid crystal display device. Note that a common electrode and an alignment layer to be formed on the red, green, and blue colored layers are not illustrated.

### Comparative Example 2

FIG. 7 is a cross-sectional view schematically illustrating a configuration of a color filter substrate according to Comparative Example 2.

As illustrated in FIG. 7, a color filter substrate 400 of Comparative Example 2 has on a transparent substrate 41 a light-shielding layer 43 made of a photosensitive resin containing a black pigment. Colored layers of red, green, and blue each are arranged from a light transmission region 422 not having the light-shielding layer 43 arranged therein to a light-shielding region 421 having the light-shielding layer 43 arranged therein. Note that FIG. 7 illustrates the boundary portion of a red colored layer 42R and a green colored layer 420, and thus does not illustrate a blue colored layer. The green colored layer 420 and the red colored layer 42R are formed such that the layers do not overlap with each other. However, the layers form bulges by being arranged on the light-shielding layer 43, and thus the color filter substrate 400 may possibly destabilize the alignment of liquid crystal molecules and decrease display qualities when provided in a liquid crystal display device. Note that a common electrode and an alignment layer to be formed on the red, green, and blue colored layers are not illustrated.

### Comparative Example 3

FIG. 8 is a cross-sectional view schematically illustrating a configuration of a color filter substrate according to Comparative Example 3.

As illustrated in FIG. 8, a color filter substrate 500 of Comparative Example 3 does not have a light-shielding layer made of a black material providing a high light-shielding effect. Instead, three colored layers of a red colored layer 52R, a green colored layer 520, and a blue colored layer 52B are laminated on a transparent substrate 51 so that a light-shielding region 521 is formed between light transmission regions 522. In the light-shielding region 521, the colored layers 52R, 520, and 52B each have a smaller thickness than in the light transmission regions 522, that is, a thickness about half the thickness in the light transmission region 522 in order to achieve a sufficient light-shielding effect. Since those three colored layers 52R, 520, and 52B are laminated in the light-shielding region 521, the light-shielding region 521 is still bulging compared to the light transmission region 522. The color filter substrate 500 therefore may possibly destabilize the alignment of liquid crystal molecules and decrease display qualities when provided in a liquid crystal display device. Note that a common electrode and an alignment layer to be formed on the red, green, and blue colored layers are not illustrated.

### Comparative Example 4

FIG. 9 is a cross-sectional view schematically illustrating a configuration of a color filter substrate according to Comparative Example 4.

As illustrated in FIG. 9, a color filter substrate 600 of Comparative Example 4 does not have a light-shielding layer made of a black material providing a high light-shielding effect. Instead, three colored layers of a red colored layer 62R, a green colored layer 62G, and a blue colored layer 62B are laminated on a transparent substrate 61 so that a light-shielding region 621 is formed between light transmission regions 622. In the light-shielding region 621, the colored layers 62R, 62G, and 62B each have a smaller thickness than in the light transmission region 622, that is, a thickness about one third of the thickness in the light transmission regions 622, in order to improve the flatness of the color filter substrate 600. When provided in a liquid crystal display device, the color filter substrate 600 can suppress destabilization of the liquid crystal molecule alignment, but may not be able to provide a sufficient light-shielding effect. Note that a common electrode and an alignment layer to be formed on the red, green, and blue colored layers are not illustrated.

The present application claims priority to Patent Application No. 2007-308657 filed in Japan on Nov. 29, 2007 under the Paris Convention and provisions of national law in a designated State, the entire contents of which are hereby incorporated by reference.

### BRIEF DESCRIPTION OF DRAWINGS

FIG. 1 is a cross-sectional view schematically illustrating the configuration of the color filter substrate according to Embodiment 1.

FIG. 2 is a schematic view illustrating the cross section in the vicinity of the color filter substrate in the liquid crystal display panel, illustrating a relationship between the color filter substrate according to Embodiment 1 and the alignment of the liquid crystal molecules applied with no voltage.

FIG. 3 is a cross-sectional view schematically illustrating the exposure process of the colored layer in the production process of the color filter substrate according to Embodiment 1.

FIG. 4 is a cross-sectional view schematically illustrating the shape of the colored layer after the exposure process in the production process of the color filter substrate according to Embodiment 1.

FIG. 5 is a cross-sectional view schematically illustrating the configuration of the color filter substrate according to Embodiment 2.

FIG. 6 is a cross-sectional view schematically illustrating the configuration of the color filter substrate according to Comparative Example 1.

FIG. 7 is a cross-sectional view schematically illustrating the configuration of the color filter substrate according to Comparative Example 2.

FIG. 8 is a cross-sectional view schematically illustrating the configuration of the color filter substrate according to Comparative Example 3.

FIG. 9 is a cross-sectional view schematically illustrating the configuration of the color filter substrate according to Comparative Example 4.

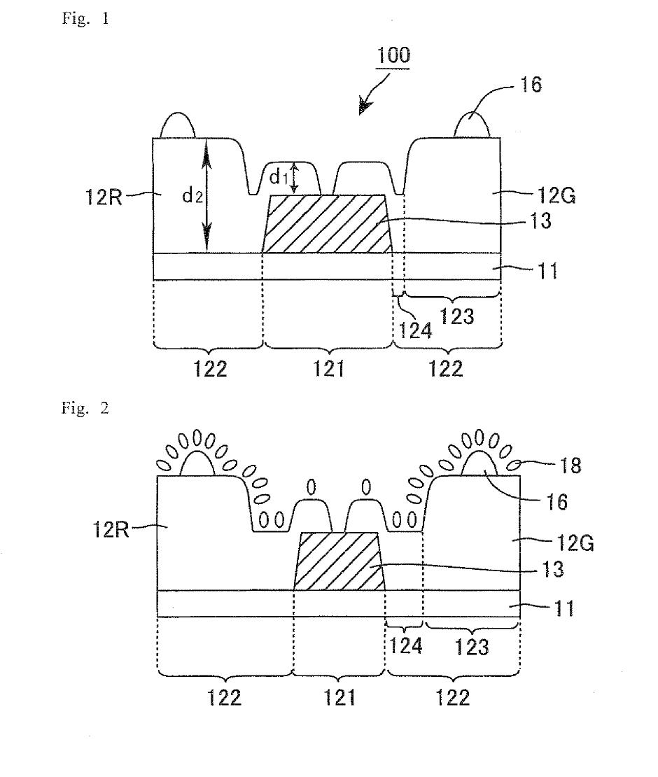

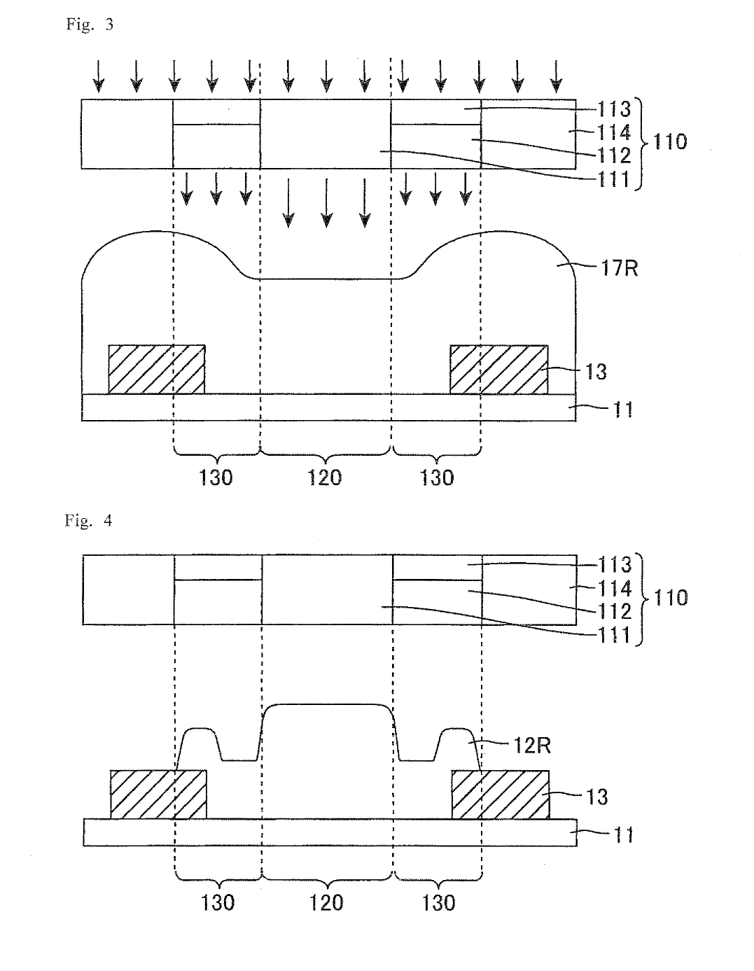

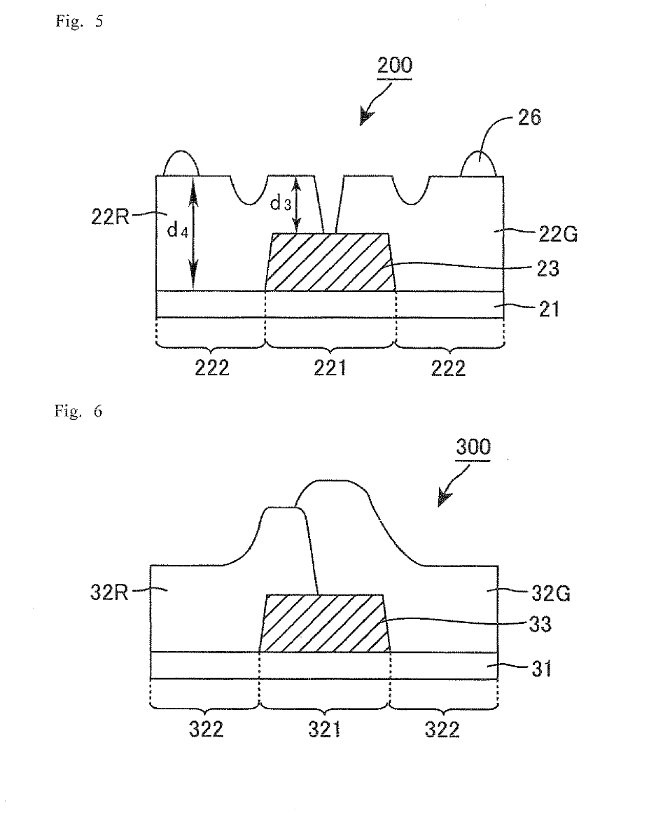

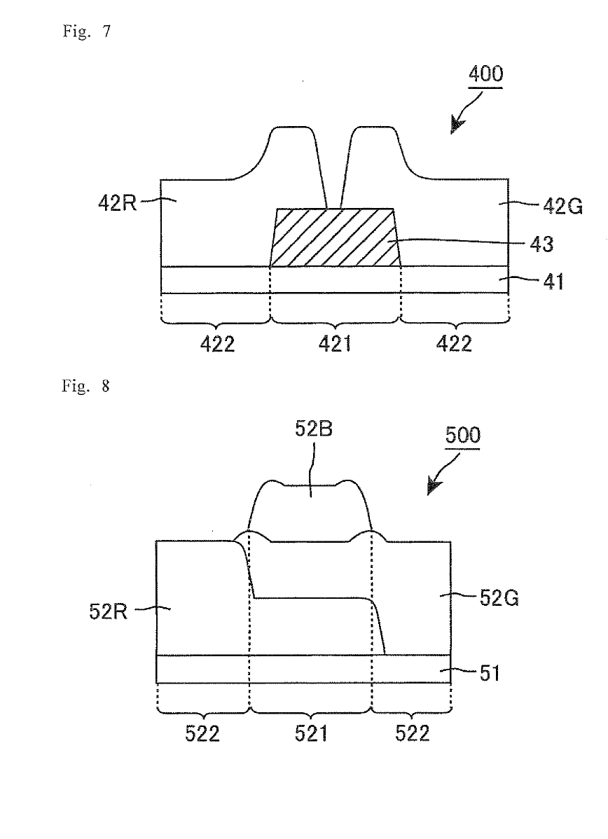

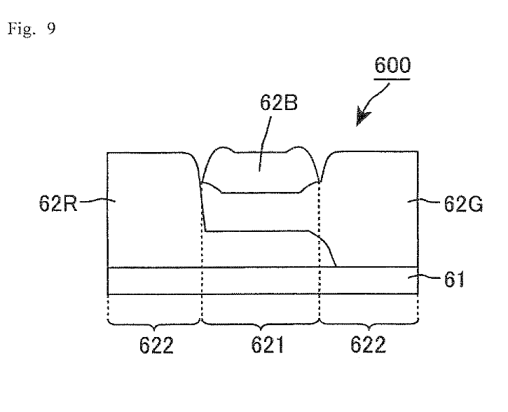

### EXPLANATION OF NUMERALS AND SYMBOLS

11, 21, 31, 41, 51, 61: Transparent substrate
12R, 22R, 32R, 42R, 52R, 62R: Red colored layer
12G, 22G, 32G, 42G, 52G, 620: Green colored layer
13, 23, 33, 43: Light-shielding layer
16: Projection for liquid crystal alignment control
17R: Transparent photosensitive resin
18: Liquid crystal molecule
52B, 62B: Blue colored layer
100, 200, 300, 400, 500, 600: Color filter substrate
110: Half-tone mask
111, 112: Light transmission member
113, 114: Light-shielding member
120: Exposure region
121, 221, 321, 421, 521, 621: Light-shielding region
122, 222, 322, 422, 522, 622: Light transmission region
123: Center part of light transmission region
124: End of light transmission region
130: Half exposure region

1. A color filter substrate comprising:
a light-shielding layer and a colored layer on a substrate,
wherein the colored layer is arranged from a light transmission region not having the light-shielding layer arranged therein to a light-shielding region having the light-shielding layer arranged therein, and has a smaller thickness in the light-shielding region than in the light transmission region.

2. The color filer substrate according to claim 1,
wherein the colored layer includes a first colored layer and a second colored layer that are adjacent to each other, sandwiching the light-shielding layer, and do not overlap with each other in the light-shielding region.

3. The color filter substrate according to claim 1,
wherein the colored layer has a smaller thickness at a part ranging from the light-shielding region to an end of the light transmission region, than at a center part of the light transmission region.

4. The color filter substrate according to claim 1,
wherein the total thickness of the light-shielding layer and the colored layer in the light-shielding region is not larger than a thickness of the colored layer in the light transmission region.

5. The color filter substrate according to claim 1,
wherein the colored layer in the light-shielding region is arranged on the light-shielding layer.

6. A liquid crystal display panel comprising the color filter substrate according to claim 1.

7. The liquid crystal display panel according to claim 6,
wherein the liquid crystal display panel provides display in a vertical alignment mode.

8. A liquid crystal display device comprising the liquid crystal display panel according to claim 6.

9. A production method of the color filter substrate according to claim 1,
comprising the step of forming the colored layer by exposing through a half-tone mask or a gray tone mask a photosensitive material arranged on the substrate.
